(19) United States
(12) Patent Application Publication
(10) Pub. No.: US 2006/0226678 A1
(43) Pub. Date: Oct. 12, 2006

(54) SIDE WINDOW DEFLECTOR FOR A VEHICLE

(76) Inventor: Wen-Hsun Chang, Tainan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,514

(22) Filed: Nov. 28, 2005

(30) Foreign Application Priority Data
Apr. 8, 2005 (TW) 094205578

(51) Int. Cl. B62D 35/00

(52) U.S. Cl. 296/180.1

(57) ABSTRACT

A side window deflector for a vehicle, wherein a groove is formed in a back surface of the side window deflector, and a row of light emitting diodes is arranged in the groove, The row of light emitting diodes (LEDs) is connected to an end of a conductive wire, another end of the conductive wire is connected to a power source of a vehicle, a double-sided tape is attached to the groove of the side window deflector to cover the light emitting diodes in the groove and to combine the side window deflector to the vehicle. An electronic light is selectively arranged in the groove. When driving the vehicle at night or in poor visibility, the flash of the LEDs or the light of the electronic light can give a warning to the driving persons coming oppositely. In addition, the flash of the LEDs makes the vehicle more attractive in appearance.

### BACKGROUND OF THE INVENTION

1. Field of the Invention

The present invention relates to an accessory of a vehicle, and more particularly to a side window deflector for a vehicle.

1. Description of the Prior Art

A side window deflector is usually used to protect the side window from undesired sunlight and rain that might directly enter a vehicle via seams between a window glass and a window frame. However, a disadvantage of the existing side window deflector is that the outward protrusion of the window pane is not in harmony with the appearance of the vehicle.

The present invention has arisen to mitigate and/or obviate the afore-described disadvantage.

### SUMMARY OF THE INVENTION

The primary objective of the present invention is to provide a side window deflector for a vehicle, wherein a groove is formed on a back surface of the side window deflector made of transparent material, and a row of light emitting diodes is arranged in the groove, an end of the row of light emitting diodes is connected to an end of a conductive wire, another end of the conductive wire is connected to a power source of a vehicle, a double-sided tape is attached to the groove of the side window deflector so as to cover the light emitting diodes in the groove and to combine the side window deflector to the vehicle. In the groove, an electronic light can be selectively attached inside the groove. When driving the vehicle at night or in poor visibility, the flash of the LED or the light of the electronic light can give a warning to other driving persons coming oppositely. In addition, the flash of the LED makes the vehicle more attractive.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a side window deflector for a vehicle in accordance with the present invention;

FIG. 2 is a cross-sectional side view of the side window deflector for a vehicle along line A-A in FIG. 1;

FIG. 3 is an exploded perspective view of the side window deflector for a vehicle in FIG. 1;

FIG. 4 is an exploded perspective view of another embodiment of the side window deflector for a vehicle in accordance with the present invention;

FIG. 5 is a cross-sectional view of the side window deflector for a vehicle in FIG. 4;

FIG. 6 is an illustrative perspective view of showing that the side window deflector in FIG. 3 is installed on a vehicle;

FIG. 6A is an enlarged perspective view of showing that the side window deflector in FIG. 3 is installed on a vehicle;

FIG. 7 is another illustrative perspective view of showing that the side window deflector in FIG. 4 is installed on a vehicle; and

FIG. 7A is an enlarged perspective view of showing that the side window deflector in FIG. 4 is installed on a vehicle.

### DETAILED DESCRIPTION OF THE PREFERRED EMBODIMENTS

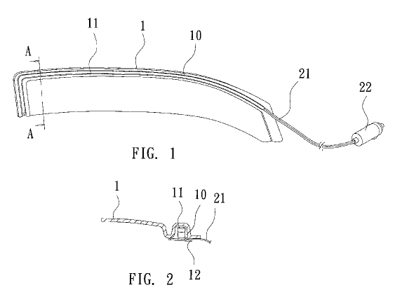

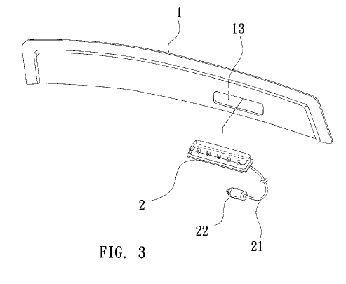

Referring to FIGS. 1 and 2, a side window deflector in accordance with the present invention is shown. In a back surface of the side window deflector 1 is an elongated body made of transparent material and provided with a groove 10 in which being arranged with a row of light emitting diodes (LEDs) 11 sequentially connected one by one, and an end conductive wire 21 is connected to an external end of the row of light emitting diodes 11. Another end of the conductive wire 21 is adapted to connect to the cigar-lighter plug 22 to provide electricity to the LEDs or a turn-signal circuit (not shown) that enables to adjust flash frequency, colors, brightness of the LEDs. A double-sided tape 12 is adhered to opening edges of the groove 10 of the side window deflector 1 to cover the LEDs 11 in the groove 10 and to attach the side window deflector 1 to the vehicle. As shown in FIG. 3, the side window deflector 1 is provided with an elongated hole 13 in which a LED socket 2 is mounted therein and electrically connected to the conductive wire 21. Likely, the LED socket 2 also can be positioned by a double-sided tape.

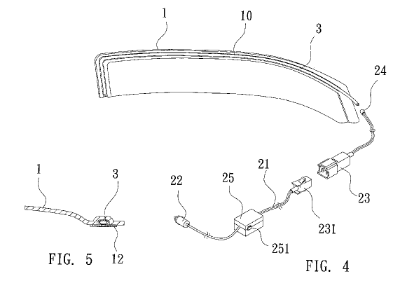

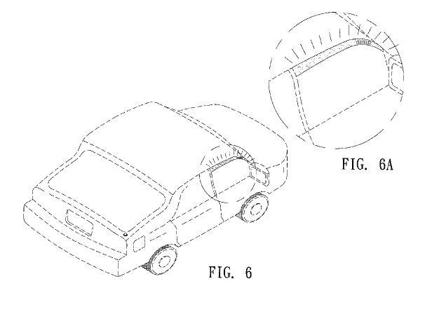

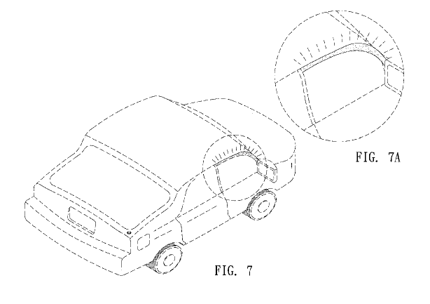

Referring to FIGS. 4 and 5 which show another embodiment of the present invention, the groove 10 of the side window deflector 1 is arranged with an electronic light or luminescence 3 that is inserted in a socket 24 at end. A driver 25 has one end adapted to connect the cigar-lighter plug 22 via the conductive wire 21 to provide electricity to the LEDs or to a turn-signal circuit (not shown) that enables to adjust flash frequency, colors, brightness of the LEDs, and has another end connected to a male adapter 231. Moreover, a switch 251 is mounted on the driver 25 to actuate the driver 25. The socket 24 is connected to a female adapter 23 by another period of the conductive wire 21. When the male adapter 231 is inserted into the female adapter 23, the electronic luminescence 3 can produce light. The double-sided tape 12 is adhered to opening edges of the groove 10 of the side window deflector 1 to cover the electronic luminescence 3 in the groove 10 and to glue the side window deflector 1 to the vehicle. The cigar-lighter plug 22 is inserted into an electricity socket (not shown) inside the vehicle. When driving the vehicle at night or in poor visibility, the flash of the LEDs 11 or the light of the electronic luminescence 3, as shown in FIGS. 6, 6A, 7 and 7A, can give a warning to the driving persons coming oppositely. In addition, the flash of the LEDs 11 makes the vehicle more attractive.

While we have shown and described various embodiments in accordance with the present invention, it should be clear to those skilled in the art that further embodiments may be made without departing from the scope of the present invention.

What is claimed is:

1. A side window deflector for a vehicle comprising:
an elongated body made of transparent body;
a groove formed in a back surface of the elongated body of the side window deflector;
a row of light emitting diodes arranged in the groove, wherein the row of light emitting diodes is electrically connected to an end of a conductive wire, another end of the conductive wire adapts to electrically connect to a power source of a vehicle; and
a double-sided tape attached to opening edges of the groove of the side window deflector to cover the light emitting diodes in the groove and to combine the side window deflector to the vehicle.

2. The side window deflector for a vehicle as claimed in claim 1, wherein an elongated hole is defined in the side window deflector for reception of a light emitting diode socket;
the light emitting diode socket is adapted to connect to an cigar-lighter plug of the vehicle by the conductive wire and the cigar-lighter plug adapts to insert into a cigar-lighter socket inside the vehicle.

3. The side window deflector for a vehicle as claimed in claim 1, wherein the row of light emitting diodes is adapted to connect to an cigar-lighter plug of the vehicle by the conductive wire and the cigar-lighter plug adapts to insert into a cigar-lighter socket inside the vehicle.

4. The side window deflector for a vehicle as claimed in claim 1, wherein the row of light emitting diodes is adapted to connect to turn-signal circuit in the vehicle by the conductive wire.

5. A side window deflector for a vehicle comprising:
an elongated body made of transparent material;
a groove formed in a back surface of the elongated body of the side window deflector;
an electronic light arranged in the groove;
a double-sided tape attached to opening edges of the groove of the side window deflector to cover the electronic light in the groove, wherein the electronic light is connected to a driver by a conductive wire;
the driver adapts to be electrically connected to a power source of a vehicle by another conductive wire, and is provided with a switch for controlling the electronic light.

6. The side window deflector for a vehicle as claimed in claim 5, wherein the driver is adapted to connect to a cigar-lighter plug via the conductive wire, and then the cigar-lighter plug adapts to be connected to a cigar-lighter socket of the vehicle.

7. The side window deflector for a vehicle as claimed in claim 5, wherein the driver is adapted to connect to turn-signal circuit of the vehicle via the conductive wire.
